(19) United States
(12) Patent Application Publication
(10) Pub. No.: US 2013/0024530 A1
(43) Pub. Date: Jan. 24, 2013

(54) APPARATUS AND METHOD FOR PROVIDING COMMUNITY SERVICE IN PORTABLE TERMINAL

(71) Applicants: Jae-Hwan KIM, Suwon-si (KR); Young-Ho RHEE, Yongin-si (KR)

(72) Inventors: Jae-Hwan KIM, Suwon-si (KR); Young-Ho RHEE, Yongin-si (KR)

(73) Assignee: SAMSUNG ELECTRONICS CO., LTD., Suwon-si (KR)

(21) Appl. No.: 13/551,145

(22) Filed: Jul. 17, 2012

(30) Foreign Application Priority Data
Jul. 18, 2011 (KR) 10-2011-0071003

(51) Int. Cl. G06F 15/16

(52) U.S. Cl. 709/206; 709/204

(57) ABSTRACT

An apparatus and method for providing a community service in a portable terminal is provided. The apparatus includes a community management part for requesting community generation by transmitting information regarding a member constituting community in a community generation request; a control part for assigning and registering a main number identifying the community through the community generation request; and a communication part for transmitting information for the community generation, wherein the control part posts a message to the community using the main number, and the community management part obtains the information regarding the member using at least one of an address book stored on a web server which manages the address book and an address book stored on the portable terminal.

### PRIORITY

The present application claims priority under 35 U.S.C. §119(a) to a Korean patent application filed in the Korean Intellectual Property Office on Jul. 18, 2011 and assigned Serial No. 10-2011-0071003, the entire disclosure of which is incorporated herein by reference.

### BACKGROUND OF THE INVENTION

1. Field of the Invention

The present invention relates generally to a portable terminal for supporting a social network service, and more particularly, to an apparatus and a method for providing a community service that simplifies community generation and message posting in the portable terminal.

2. Description of the Related Art

Portable terminals are used by people of all ages as an effective necessity in modern life. Service providers and portable terminal manufacturers have been competitively developing products or services to distinguish themselves.

For example, advanced portable terminals are now provided as multimedia devices and thus provide various services such as a phonebook, games, a Short Message Service (SMS), Electronic (E)-mail, morning calls, a Motion Picture Expert Group (MPEG) Audio Layer-3 (MP3) player, a schedule management function, a digital camera, a multimedia message, and a wireless Internet service.

Recently, advances in wireless Internet service and the proliferation of online Social Network Services (SNSs) such that about one in four Internet users are using the SNS. The online SNS offers an environment for actively sharing and spreading individual user information and various content information (e.g., video, photo, and SMS). Using the online SNS, users can make and maintain personal connections (i.e., make friends) by sharing their personal information in a network.

Typically, the SNS creates or generates a community for sharing information and then shares the information among members of the generated community. Such an SNS cannot share the information by grouping the selected members. For example, the user can generate the community by selecting other persons having the same interest. In the generated community, the user can obtain information posted by the selected user (other person). Conversely, others selecting the user can obtain information posted by the user. A problem is that the information is shared unilaterally with the person who selects the member, not the user group.

In this regard, an apparatus and a method for addressing the problem by enhancing the community generation capability in the portable terminal are required.

### SUMMARY OF THE INVENTION

Accordingly, the present invention has been made to solve the above—stated problems occurring in the prior art, and an aspect of the present invention provides an apparatus and a method for providing a community service that simplifies community generation and message posting in a portable terminal.

Another aspect of the present invention is to provide an apparatus and a method for providing a community service that enables message posting using a message transmission manner in a portable terminal.

Yet another aspect of the present invention is to provide an apparatus and a method for generating a community with a number for distinguishing the community in a portable terminal.

According to one aspect of the present invention, an apparatus for providing a community service in a portable terminal is provided. The apparatus includes a community management part for requesting community generation by transmitting information regarding a member constituting community in a community generation request; a control part for assigning and registering a main number identifying the community through the community generation request; and a communication part for transmitting information for the community generation, wherein the control part posts a message to the community using the main number, and the community management part obtains the information regarding the member using at least one of an address book stored on a web server which manages the address book and an address book stored on the portable terminal.

According to another aspect of the present invention, an apparatus for providing a community service in a community server is provided. The apparatus includes a number management part for assigning and transmitting a main number for identifying a community to generate, to a portable terminal, when receiving a community generation request; a server control part for identifying a community to forward the received message, when receiving a message to post to the community from the portable terminal; a member management part for identifying members of the community identified by the server control part; and a message management part for transmitting the received message to the member identified by the member management part.

According to another aspect of the present invention, a method for providing a community service in a portable terminal is provided. The method includes requesting community generation by transmitting information regarding a member constituting community in a community generation request; assigning a main number which identifies the community through the community generation request; and posting a message to the community using the assigned main number, wherein the requesting of the community generation obtains the information regarding the member using at least one of an address book stored on a web server which manages the address book and an address book stored on the portable terminal.

According to another aspect of the present invention, a method for providing a community service in a community server is provided. The method includes assigning a main number for identifying a community to generate, when receiving a community generation request; transmitting the assigned main number to a portable terminal; identifying a community to forward the received message, when receiving a message to post to the community from the portable terminal; and transmitting the received message to members of the identified community.

### BRIEF DESCRIPTION OF THE DRAWINGS

The above and other aspects, features, and advantages of certain embodiments of the present invention will be more apparent from the following description taken in conjunction with the accompanying drawings, in which:

FIG. 1 is a block diagram illustrating a mobile communication system for providing a community service that simplifies community generation and message posting according to an embodiment of the present invention;

FIG. 2 is a flowchart illustrating a method for using the community service in a portable terminal according to an embodiment of the present invention;

FIG. 3 is a flowchart illustrating a method for providing the community service in a community server according to an embodiment of the present invention;

FIG. 4 is a flowchart illustrating a method for posting a voice message in the portable terminal according to an embodiment of the present invention;

FIG. 5 is a flowchart illustrating a method for posting a voice message in the community server according to an embodiment of the present invention;

FIG. 6 is a diagram illustrating a method for establishing the community in a mobile communication system according to an embodiment of the present invention; and

FIG. 7 is a diagram illustrating a method for providing the community service in the mobile communication system according to an embodiment of the present invention.

### DETAILED DESCRIPTION OF EMBODIMENTS OF THE PRESENT INVENTION

The following description with reference to the accompanying drawings is provided to assist in a comprehensive understanding of embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

Embodiments of the present invention provide an apparatus and a method for generating a community based on an address book to provide a community service by simplifying community generation and message posting in a portable terminal. The community service indicates a social network service for sharing information in the community established with members.

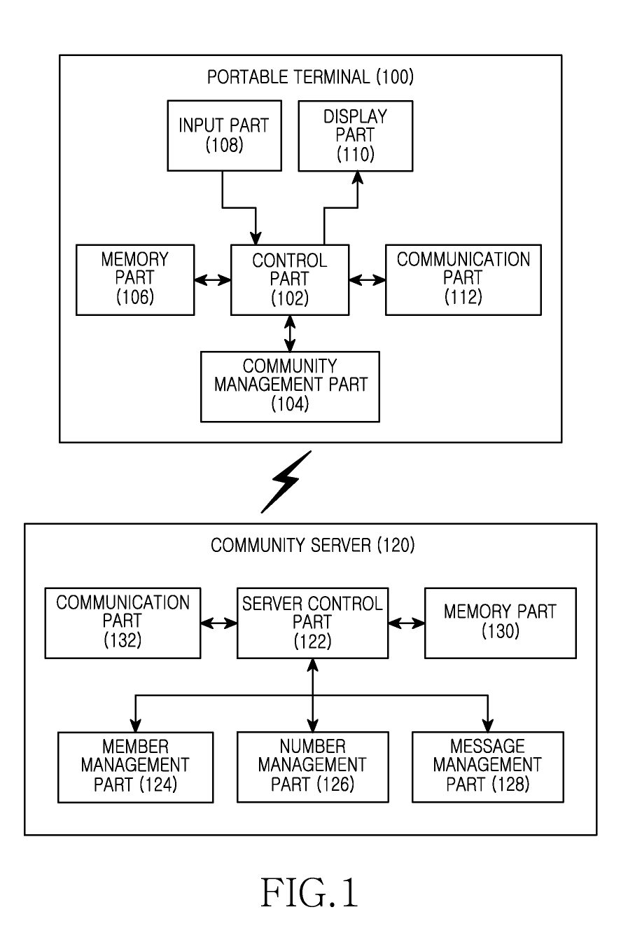

FIG. 1 is a block diagram illustrating a mobile communication system for providing a community service that simplifies community generation and message posting according to an embodiment of the present invention.

Referring to FIG. 1, the mobile communication system includes a portable terminal 100 and a community server 120. The portable terminal 100 includes a control part 102, a community management part 104, a memory part 106, an input part 108, a display part 110, and a communication part 112.

The control part 102 of the portable terminal 100 controls operations of the portable terminal 100. For example, the control part 102 processes and controls voice communication and data communication. Aside from these typical functions, the control part 102 performs processes to provide the community service that simplifies community generation and message posting.

In so doing, the control part 102 requests the community generation by transmitting information of members of an address book to the community server 120, and then processes to provide the community service using a community main number assigned from the community server 120. The community main number indicates an identification number for identifying the community generated through the community service.

Accordingly, when posting a message to the generated community, the control part 102 sends a message to the assigned main number and processes to post the community message.

The method described below may be provided as one or more instructions in one or more software modules stored in the memory part 106. The software modules may be executed by the control part 102.

The community management part 104 obtains community information of the community to generate under control of the control part 102. The community information includes a name and member information of the community to generate. The member information can be selected from address book information stored in on the web that manages the address book information or the portable terminal 100.

The community management part 104 may be called as another control part 102.

The memory part 106 includes Read Only Memory (ROM), Random Access Memory (RAM), and flash ROM. The ROM stores microcodes and reference data of a program for processing and controlling the control part 102 and the community management part 104.

The RAM, which is an operating memory of the control part 102, stores temporary data generated during the program execution. The flash ROM contains updatable data such as phonebook information, outgoing messages, incoming messages, and the like. In an embodiment of the present invention, the flash ROM contains community messages transmitted in the community of the portable terminal 100 and the address book of the members for constituting the community.

The method executed by the community management part 104 may be provided as one or more instructions in one or more software modules stored in the memory part 106. In that case, the software modules may be executed by the control part 110.

The input part 108 includes a plurality of function keys such as number keys 0-9, a menu key, a cancel key, an OK key, a call key, an end key, an Internet access key, navigation keys (or direction buttons), character input keys, and the like. The input part 108 provides the control part 102 with key input data corresponding to the key pressed by the user. In addition, the input part 108 inputs information required to generate the community and contents of the message to post to the community.

The display part 110 displays status information, characters, videos, and still images during the operation of the portable terminal 100. The display part 110 can be implemented as a color Liquid Crystal Display (LCD), an Active Matrix Organic Light Emitting Diode (AMOLED), and the like. A touch sensitive display, called as a touchscreen, may be used as the display part 110. In this situation, touch input may be performed via the touch sensitive display. In addition, the display part 110 outputs information generating in the community.

The communication part 112 processes to transmit and receive radio signals of data input and output via an antenna (not illustrated). For instance, in the transmission, the communication part 112 channel-encodes, spreads, Radio Frequency (RF)-processes, and transmits data. In the reception, the communication part 112 converts the received RF signal into a baseband signal and restores the data by de-spreading and channel-decoding the baseband signal. Additionally, the communication part 112 transmits and receives the information for the community generation and the message to post in the community.

While the control part 102 of the portable terminal 100 can function as the community management part 104, they are separately illustrated to distinguish various functions of the present invention, without limiting the scope of the invention. One skilled in the art would understand that various modifications can be made without departing from the spirit and scope of the invention. For example, the control part 102 can process all of the functions of the community management part 104.

The community server 120 includes a server control part 122, a member management part 124, a number management part 126, a message management part 128, a memory part 130, and a communication part 132.

The server control part 122 of the community server 120 provides the community service that simplifies the community generation and the message posting. The server control part 122 assigns the information representing the community as the phone number according to the community generation request and allows to post the message of the member by sending the message.

The server control part 122 sends the message requesting the communication subscription to the member of the generated community. The member of the community can be the member in the address book set by the user of the portable terminal 100.

The server control part 122 manages the address book posted by the user who requests the community generation. The address book managed as such can be used as the member information for the community generation.

The method described below may be provided as one or more instructions in one or more software modules stored in the memory part 130 of the community server 120. The software modules may be executed by the server control part 122.

The message management part 128 sends a message for inviting the member of the generated community under the control of the server control part 122. The message management part 128 forwards the community message to the member of the community and stores the transmitted community message as log information of the corresponding community. Herein, the community message is the message to post via the community service.

The member management part 124 manages the community main number to be assigned to the user who requests the community generation, and assigns different main numbers to the communities. In so doing, the member management part 124 assigns the community main number that includes a telephone exchange number indicating the community service and a number identifying the community.

The member management part 124 manages the address book of the user who requests to generate the community. When receiving the community generation request from the portable terminal 100, the member management part 124 provides the address book information to the portable terminal 100 to select the member for the community.

The memory part 130 stores microcodes and reference data of a program for operating the community server 120. The communication part 132 communicates with the portable terminal 100, and transmits and receives the information for the community generation.

While the message management part 128, the number management part 126, and the member management part 124 are included in the community server 120, they can also constitute servers independent of the community server 120. For example, they can constitute a message server, a number management server, and a member management server.

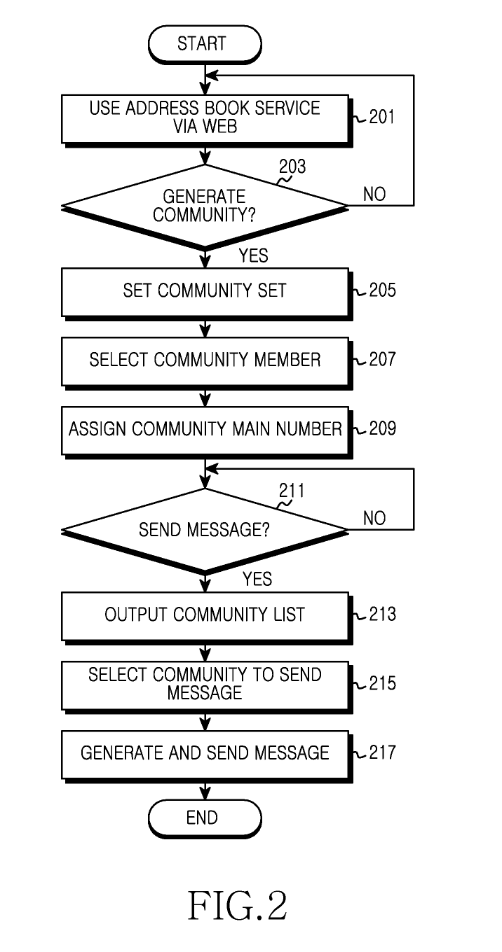

FIG. 2 is a flowchart illustrating a method for using the community service in the portable terminal according to an embodiment of the present invention.

After using the address book service via the web in step 201, the portable terminal determines whether the user requests to generate the community in step 203. The community generation indicates the grouping to share the information.

When the community generation is not requested in step 203, the portable terminals proceeds to step 201.

Upon confirming the community generation request in step 203, the portable terminal generates the community.

To generate the community, the portable terminal sets the name of the community to generate in step 205 and selects the community member in step 207. The portable terminal can select the member of the desired community from a list of users stored in the web providing the address book service.

Upon setting the name and the member of the community, the portable terminal transmits the name and member information of the community to the community server. This is to make the community server assign the main number (the identification number) for the community to be generated by the user and manage the community information (e.g., the member information and the message information).

In step 209, the portable terminal is assigned the main number for the community from the community server. A conventional community service searches for and selects the community for posting the message. However, the user of the portable terminal according to an embodiment of the present invention can post the message by sending the message to post using the main number of the corresponding community as a recipient number. For example, when “111-222-3333” is assigned as the main number of the community, the portable terminal can send a short message or a multimedia message to the member of the community with the main number and thus post contents of the message. The telephone exchange number indicating the community in the main number of the community is different from a carrier code of the mobile communication system and an area code. That is, “111” of the main number are the telephone exchange numbers indicating the number for the community service, and “222-3333” are the numbers for identifying the community generated in the community service.

In step 211, the portable terminal determines whether to send the community message. Herein, the written message is transmitted and posted to the community of the user of the portable terminal.

When not sending the community message in step 211, the portable terminal repeats step 211.

When sending the community message in step 211, the portable terminal outputs a community list of the portable terminal in step 213. The user selects the community for sending the message in step 215. When the community is selected to send the message, the portable terminal outputs a screen for writing the message to send to the community. Also, the portable terminal can directly input the community main number in the recipient information within the message-writing screen and then send the written message.

After writing the message, the portable terminal sends the written message to the community server in step 217. Thus, the community server identifies the community to forward the message by confirming the main number of the community in the received message, and processes to forward the received message to the member of the community.

The portable terminal then finishes this process.

While the message is transmitted to the registered community in FIG. 2, the portable terminal can receive the messages posted by the members of the community from the community server. Contents of the message posted by the member are stored on the server as the log information. The member can be verified as the member of the community through a simple authentication process and then obtain the log information; that is, history information of all the posted messages.

While the community is generated using the address book service via the web in FIG. 2, the community may be generated using the address book information of the portable terminal.

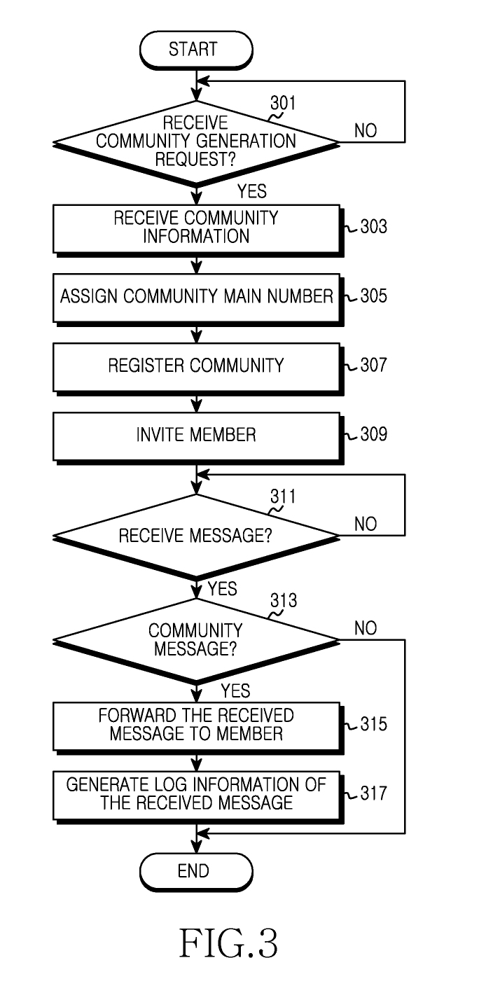

FIG. 3 is a flowchart of a method for providing the community service in the community server according to an embodiment of the present invention.

In step 301, the community server determines whether the community generation request is received. Herein, the community server can be a server that provides the address book service.

When not receiving the community generation request in step 301, the community server repeats step 301.

By contrast, when receiving the community generation request in step 301, the community server receives the community information from the terminal that wants to generate the community in step 303. The community information received by the community server includes the name and the member information of the community to generate.

The community server assigns the main number of the community to be generated by the portable terminal in step 305 and posts the assigned main number and the community information in step 307.

In step 309, the community server invites the member. In step 309, the message for subscribing to the generated community is sent to the members of step 303. The community server fulfils the step by sending an invitation message including the community information to promote the subscription and a callback Uniform Resource Locator (URL) for responding to the subscription.

In step 311, the community server determines whether a message is received.

When receiving no message in step 311, the community server repeats step 311.

Upon receiving a message in step 311, the community server determines whether the received message is a community message in step 313. Herein, the community message is the message to post via the community service, and transmitted with the main number of the community. That is, the members of the community send this message to the member of the corresponding community, and the message includes the telephone exchange number indicating the community message and the community main number for identifying the community.

When the received message is not the community message in step 313, the community server finishes this process. In so doing, the community server can identify the community message by checking the telephone exchange number indicating the community in the received message.

However, when the received message is the community message in step 313, the portable terminal identifies the community for posting the message by checking the community main number in the received community message in step 315. The community server then confirms the information of the members in (subscribed to) the identified community and then processes to forward the received message to the members.

In step 317, the community server generates the log information of the received message. The log information of the received message is the history information of the contents of the posted message in the corresponding community. After an authentication process, the user of the community obtains the log information.

The community server then finishes this process.

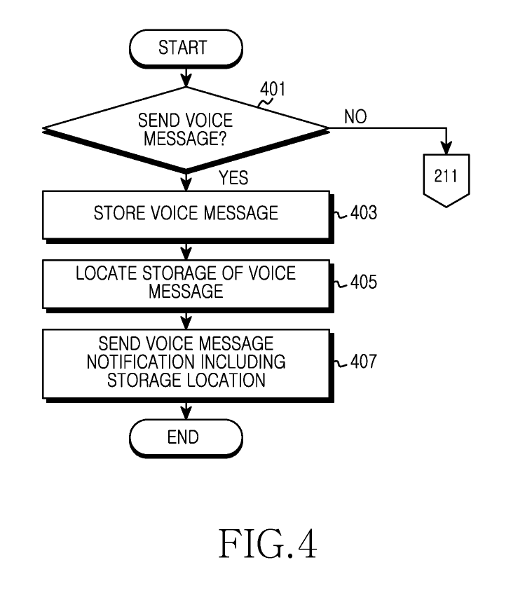

FIG. 4 is a flowchart illustrating a method for posting a voice message in the portable terminal according to an embodiment of the present invention.

In step 401, the portable terminal determines whether to send a voice message. The voice message indicates a voice message pre-stored by the user, and includes a video message and an Internet Protocol (IP)—based voice call (message).

When not sending the voice message in step 401, the portable terminal determines whether to send a text message in step 211 of FIG. 2.

When determining to send the voice message in step 401, the portable terminal stores the voice message generated using voice recording or video recording in step 403. The portable terminal can store the generated voice message to the community server or a particular server allowing the data sharing.

After locating the storage of the voice message in step 405, the portable terminal sends a voice message notification including the information regarding the storage location of the voice message to the community server in step 407.

Hence, the community server receiving the voice message notification can inform the member of the corresponding community of the voice message posting.

The portable terminal then finishes this process.

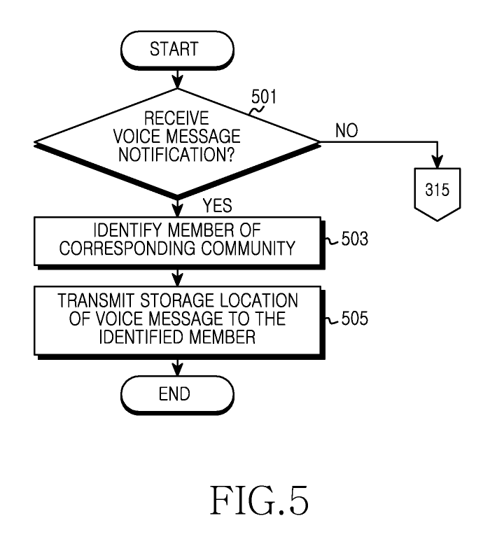

FIG. 5 is a flowchart of a method for posting a voice message in the community server according to an embodiment of the present invention.

In step 501, the community server determines whether the voice message notification is received from the terminal.

When not receiving the voice message notification in step 501, the community server identifies the community for posting the message by checking the community main number in the received text message in step 315 of FIG. 3.

When receiving the voice message notification in step 501, the community server identifies the member of the corresponding community in step 503. The voice message notification, which is an example of the community message, includes the community main number including the telephone exchange number indicating the community message and the number for identifying the community. Accordingly, the community server can identify the members of the community using the community main number. Also, the community server pre-stores the main numbers of the communities and the member information of the communities corresponding to the main numbers.

In step 505, the community server sends the storage location of the voice message to the member identified in step 503 and generates the log information for the received voice message notification.

The community server then finishes this process.

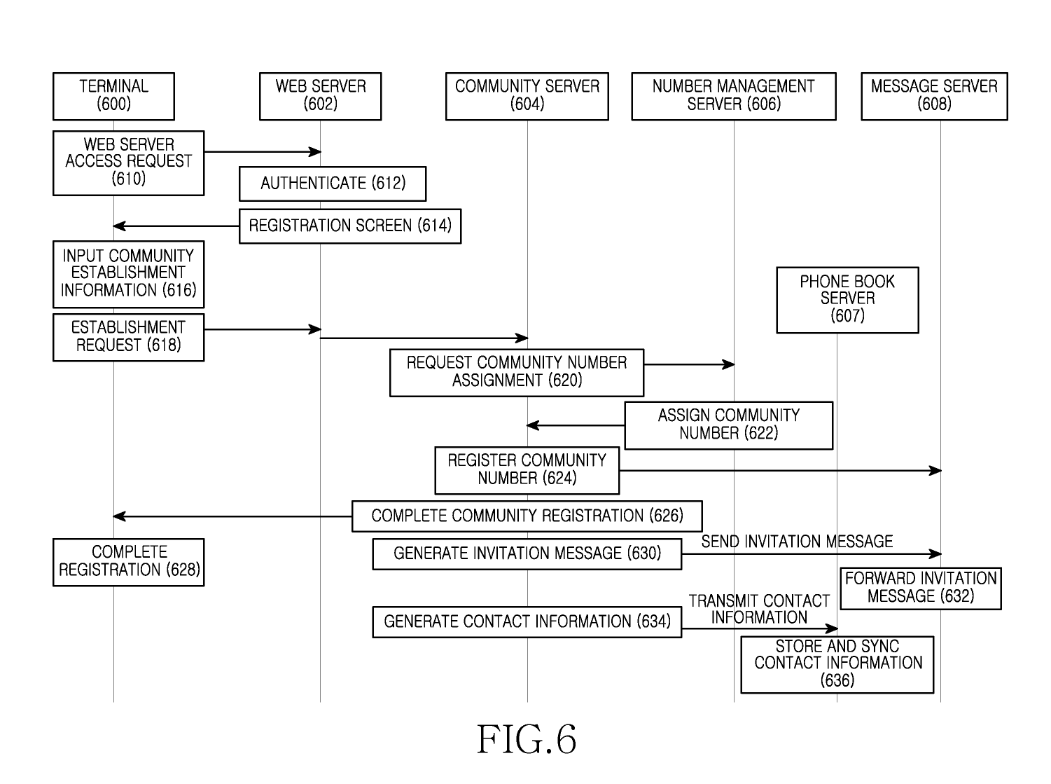

FIG. 6 is a diagram illustrating a method for establishing the community in a mobile communication system according to an embodiment of the present invention.

Referring to FIG. 6, the mobile communication system includes a terminal 600, a web server 602, a community server 604, a number management server 606, a phone book server 607, and a message server 608.

The terminal 600 is a portable terminal used by the user to receive the community service. The terminal 600 can be implemented using a personal PC, a Personal Digital Assistant (PDA), and the like.

When receiving a web server access request from the user in step 610, the terminal 600 performs the authentication with the web server 602 in step 612. When completing the authentication, the web server 602 outputs a screen for the community registration in step 614.

After the information for the community establishment is input in step 616, the terminal 600 requests the community establishment to the web server 602 in step 618. In so doing, the terminal 600 can select the members of the community to establish from the address book provided from the web server 602 or the address book stored on the terminal 600, and provide the web server 602 with the selected member information and the community name information.

The web server 602 receiving the establishment request forwards the received community establishment information to the community server 604.

The community server 604 requests the community main number corresponding to the establishment request to the number management server 606 in step 620. The number management server 606 assigns and provides the corresponding community number to the community server 604 in step 622. Thus, the number management server 606 assigns the main number including the telephone exchange number indicating the community service and the number for identifying the generated community.

After posting the community with the assigned main number in step 624, the community server 604 notifies the community establishment and registration completion to the terminal 600 in step 626. The terminal 600 receiving the notification informs the user of the community registration completed in step 628.

The community server 604 generates the invitation message recommending the community subscription to the members received from the terminal 600 in step 630, and then sends the invitation message to the message server 608. Hence, the message server 608 forwards the received invitation message to the individual community member in step 632.

Next, the community server 604 generates contact information which is the information of the members subscribed to the community in step 634, sends the contact information to the phone book server 607 which manages the address book corresponding to the terminal, and synchronizes the contact information and the phone book in step 636. The contact information can be the information of the community of the terminal and the members of the community connected to the terminal.

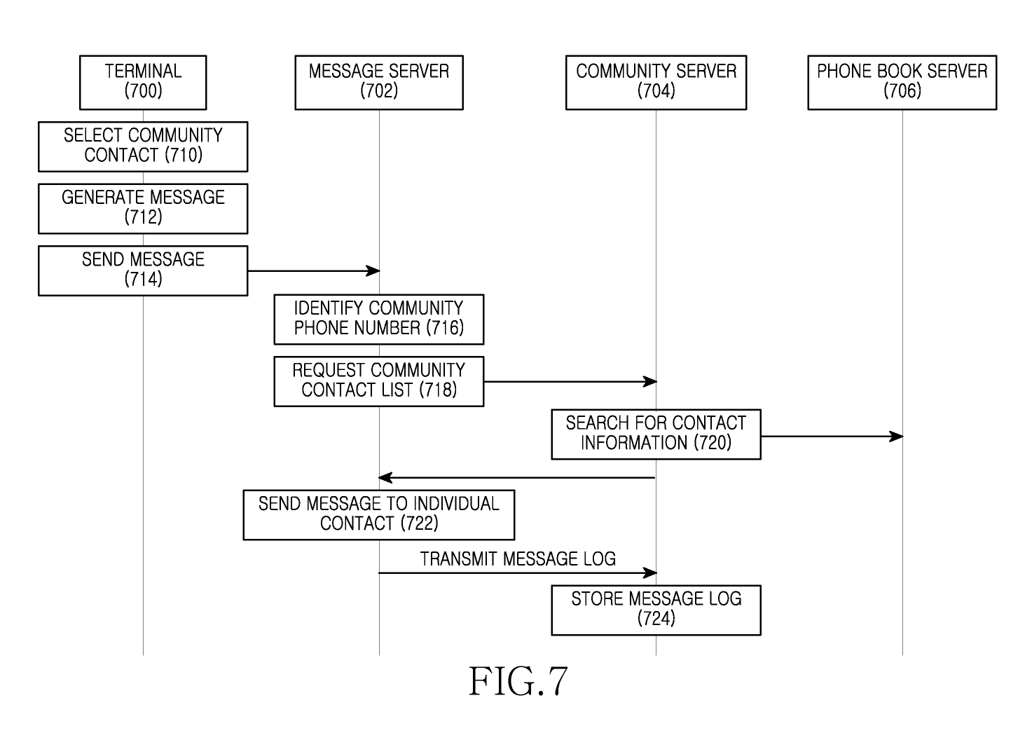

FIG. 7 illustrates a method for providing the community service in the mobile communication system according to an embodiment of the present invention.

Referring to FIG. 7, the mobile communication system includes a terminal 700, a message server 702, a community server 704, and a phone book server 706.

The terminal 700 selects the community contact in step 710. As the terminal 700 selects the contact, the community of the terminal 700 and the member of the community connected to the terminal 700 are selected.

The terminal 700 then generates a message to transmit using the selected contact in step 712 and sends the generated message to the message server 702 in step 714. For example, the terminal 700 can generate the message by selecting a particular community or member of the community in the phone book of the message server 702, and send the generated message by inputting a message send button. Thus, the recipient number of the generated message is the main number of the selected contact, and the terminal 700 can send URL information for the text data, the image data, and the voice message. When not obtaining the main number of the selected contact, the terminal 700 can obtain e-mail address information of the selected contact and send the message to the corresponding contact.

The message server 702 receiving the message determines whether the received message is the community message in step 716. The message server 702 identifies the community message by checking the telephone exchange number indicating the community in the received message.

When the received message is the community message, the message server 702 requests a community contact list by forwarding the received message to the community server 704 in step 718.

Thus, the community server 704 searches for the contact information by accessing the phone book server 706 in step 720, and sends the contact information to the message server 702. The message server 702 forwards the received message to the member that is the individual contact in step 722.

The community server 704 forwards the received message to the member via the message server 702, which is similar to the message server 702 requesting the contact list to the community server 704 and sending the message.

The message server 702 sending the message to the member of the community transmits the information of the transmitted message to the community server 704 and stores the log information of the received message in step 724. When there is no main number of the contact corresponding to the received message, the message server 702 can obtain the e-mail address information of the contact and send the message to the corresponding contact.

It will be appreciated that embodiments of the present invention can be implemented in the form of hardware, software or a combination of hardware and software. Any such software may be stored in the form of volatile or non-volatile storage such as, for example, a storage device like a ROM, whether erasable or rewritable or not, or in the form of memory such as, for example, RAM, memory chips, device or integrated circuits or on an optically or magnetically readable medium such as, for example, a CD, DVD, magnetic disk or magnetic tape or the like. It will be appreciated that the storage devices and storage media are embodiments of machine-readable storage that are suitable for storing a program or programs comprising instructions that, when executed, implement embodiments of the present invention. Accordingly, embodiments provide a program comprising code for implementing apparatus or a method as claimed in any one of the claims of this specification and a machine-readable storage storing such a program. Still further, such programs may be conveyed electronically via any medium such as a communication signal carried over a wired or wireless connection and embodiments suitably encompass the same.

As set forth above, the SNS simplifies communication in the community generation and the message posting in the portable terminal, the members of the community are grouped based on the address book and the message is posted to the community in the message transmission manner.

While the invention has been shown and described with reference to certain embodiments thereof, it will be understood by those skilled in the art that various changes in form and details may be made therein without departing from the spirit and scope of the invention as defined by the appended claims and their equivalents.

What is claimed is:

1. An apparatus for providing a community service in a portable terminal, the apparatus comprising:
a community management part for requesting community generation by transmitting information regarding a member constituting community in a community generation request;
a control part for assigning and registering a main number identifying the community through the community generation request; and
a communication part for transmitting information for the community generation,
wherein the control part posts a message to the community using the main number, and
wherein the community management part obtains the information regarding the member using at least one of an address book stored on a web server which manages the address book and an address book stored on the portable terminal.

2. The apparatus of claim 1, wherein the main number comprises at least one of a telephone exchange number indicating a message of a community service, and an identification number for identifying the community service.

3. The apparatus of claim 1, wherein the message posted to the community comprises at least one of a short message, a multimedia message, a voice message, an e-mail message, and a voice call based on Internet Protocol (IP).

4. The apparatus of claim 1, wherein the control part transmits a message using the main number as a recipient information.

5. An apparatus for providing a community service in a community server, the apparatus comprising:
a number management part for assigning and transmitting a main number for identifying a community to generate, to a portable terminal, when receiving a community generation request;
a server control part for identifying a community to forward the received message, when receiving a message to post to the community from the portable terminal;
a member management part for identifying members of the community identified by the server control part; and
a message management part for transmitting the received message to the member identified by the member management part.

6. The apparatus of claim 5, wherein the community generation request comprises information of a member constituting the community, and
the message management part transmits a notification message which notifies the member of the community generation to.

7. The apparatus of claim 5, wherein the message management part generates log information by storing the received message, after transmitting the received message to the members of the identified community.

8. The apparatus of claim 5, wherein the main number comprises at least one of a telephone exchange number indicating a message of a community service, and an identification number for identifying the community service.

9. A method for providing a community service in a portable terminal, the method comprising:
requesting community generation by transmitting information regarding a member constituting community in a community generation request;
assigning a main number which identifies the community through the community generation request; and
posting a message to the community using the assigned main number,
wherein the requesting of the community generation obtains the information regarding the member using at least one of an address book stored on a web server which manages the address book and an address book stored on the portable terminal.

10. The method of claim 9, wherein the main number comprises at least one of a telephone exchange number indicating a message of a community service, and an identification number for identifying the community service.

11. The method of claim 9, wherein the message posted to the community comprises at least one of a short message, a multimedia message, a voice message, an e-mail message, and a voice call based on Internet Protocol (IP).

12. The method of claim 9, wherein posting of the message to the community using the assigned main number transmits a message using the main number as a recipient information.

13. A method for providing a community service in a community server, the method comprising:
assigning a main number for identifying a community to generate, when receiving a community generation request;
transmitting the assigned main number to a portable terminal;
identifying a community to forward the received message, when receiving a message to post to the community from the portable terminal; and
transmitting the received message to members of the identified community.

14. The method of claim 13, wherein the community generation request comprises information regarding a member constituting the community, and
transmitting a notification message to the member regarding the community generation.

15. The method of claim 13, further comprising:
generating log information by storing the received message, after transmitting the received message to the members of the identified community.

16. The method of claim 13, wherein the main number comprises at least one of a telephone exchange number indicating a message of a community service, and an identification number for identifying the community service.

17. A non-transitory computer-readable recording medium having recorded thereon a computer program for executing a method of managing telephone numbers based on call history in a mobile communication system, the method comprising;
requesting community generation by transmitting information regarding a member constituting community in a community generation request;
assigning a main number which identifies the community through the community generation request; and
posting a message to the community using the assigned main number,
wherein the request of the community generation obtains the information regarding the member using at least one of an address book stored on a web server which manages the address book and an address book stored on the portable terminal.

18. The computer-readable recording medium of claim 17, wherein the main number comprises at least one of a telephone exchange number indicating a message of a community service, and an identification number for identifying the community service.

19. The computer-readable recording medium of claim 17, wherein the message posted to the community comprises at least one of a short message, a multimedia message, a voice message, an e-mail message, and a voice call based on Internet Protocol (IP).

20. The computer-readable recording medium of claim 17, wherein posting of the message to the community using the assigned main number transmits a message using the main number as a recipient information.
